(19) United States
(12) Patent Application Publication
(10) Pub. No.: US 2007/0211131 A1
(43) Pub. Date: Sep. 13, 2007

(54) Image printing device and multi-function device

(75) Inventor: Shota Iijima, Nagoya-shi (JP)

Correspondence Address: Eugene LeDonne, Esq.;Reed Smith LLP, 599 Lexington Avenue, 29th Floor, New York, NY, 10022, US

(73) Assignee: Brother Kogyo Kabushiki Kaisha

(21) Appl. No.: 11/714,983

(22) Filed: Mar. 7, 2007

(30) Foreign Application Priority Data
Mar. 7, 2006 (JP) 2006-061040

(51) Int. Cl. B41J 29/13

(52) U.S. Cl. 347/108

(57) ABSTRACT

An image printing device including (1) a first tray that holds a print medium on which an image is to be printed, (2) a first opening disposed at a front of the image printing device, in which the first tray is disposed, (3) a second opening disposed at the front of the image printing device, through which an ink cartridge is inserted and from which the ink cartridge is removed, and (4) a card slot disposed at the front of the image printing device, the card slot electrically connecting a memory card that stores image data to the image printing device. Wherein an insertion direction of the first tray into the first opening, an insertion direction of the ink cartridge into the second opening, and an insertion direction of the memory card into the card slot are made to be a first single direction.

The present invention is based on Japanese Patent Application No. 2006-061040 filed Mar. 7, 2006, the contents of which are incorporated by reference.

### BACKGROUND OF THE INVENTION

1. Field of the Invention

The present invention relates to an image printing device and a multi-function device that eject ink supplied from an ink cartridge to a sheet-like print medium, so as to record an image on the print medium.

2. Discussion of Related Art

A so-called inkjet type image printing device that selectively ejects ink from nozzles of a printhead, causing the ink to land on a sheet (an example of print media), and thereby performing image printing, is known in related art. Image printing devices are disclosed in JP-A-2002-283652 and JP-A-2002-347303 in which the front of the devices are provided with (1) a sheet-feed-tray opening through which a sheet feed tray for holding sheets is detachably attached, (2) a sheet discharge opening through which a sheet printed with an image is discharged, and (3) an ink-replacing opening through which an ink cartridge is replaced.

Card-type small-sized storage devices called memory cards in which a nonvolatile memory, such as a flash memory, is packaged, are also publicly known. Since these small-sized storage devices, which can be carried in a person's pocket, are convenient for carrying data, they have recently come into wide use. Printing image data stored in small-sized storage devices on a sheet is conventionally extremely troublesome, in that the small-sized storage device must first be connected to a personal computer (hereinafter referred to as “PC”) before the image data in the small-sized storage devices can be loaded into the PC. Then the image data is sent to an image printing device connected to a PC via a predetermined interface.

On the other hand, image printing devices integrally provided with a connector, such as a card slot, that enables direct connection with small-sized storage devices have recently come into markets. If such image printing devices are used, transfer of image data can be performed directly between a small-sized storage device and a printing device without use of a PC. Therefore, the image data in the small-sized storage devices need not be first sent to the PC.

In view of the above circumstances, it is an object of the invention to provide an image printing device having an improved layout of components, such as a sheet feed tray, an ink cartridge, and a memory card slot, as well as to offer easy access to these components. It is another object of the invention is to provide a multi-function device having such an image printing device.

### SUMMARY OF THE INVENTION

An image printing device that ejects ink supplied from an ink cartridge to a sheet-like print medium to print an image on the sheet-like print medium, the image printing device including (1) a first tray that holds a print medium on which an image is to be printed, (2) a first opening disposed at a front of the image printing device, in which the first tray is disposed, (3) a second opening disposed at the front of the image printing device, through which the ink cartridge is inserted and from which the ink cartridge is removed, and (4) a card slot disposed at the front of the image printing device, the card slot electrically connecting a memory card that stores image data to the image printing device. Wherein an insertion direction of the first tray into the first opening, an insertion direction of the ink cartridge into the second opening, and an insertion direction of the memory card into the card slot are made to be a first single direction.

A multi-function device including (1) an image printing device that ejects ink supplied from an ink cartridge to a sheet-like print medium to print an image on the print medium, and (2) an image reading device that is disposed above the image printing device so as to read an image of a predetermined document. The image printing device including (1) a first tray that holds a print medium on which an image is to be printed, (2) a first opening disposed at a front of the image printing device, in which the first tray is disposed, (3) a second opening disposed at the front of the image printing device, through which the ink cartridge is inserted and from which the ink cartridge is removed, and (4) a card slot disposed at the front of the image printing device, the card slot electrically connecting a memory card that stores image data to the image printing device. Wherein an insertion direction of the first tray into the first opening, an insertion direction of the ink cartridge into the second opening, and an insertion direction of the memory card into the card slot are made to be a first single direction.

An image printing device including a first tray, a first opening, a second opening, and a card slot. Wherein the first tray holds a print medium. Wherein the first opening is disposed at a front of the image printing device. Wherein the first tray is inserted through, and removed from, the first opening. Wherein the second opening is disposed at the front of the image printing device. Wherein an ink cartridge is inserted through, and removed from, the second opening. Wherein the card slot is disposed at the front of the image printing device. Wherein a memory card is inserted through, and removed from, the card slot. Wherein an insertion direction of the first tray into the first opening, an insertion direction of the ink cartridge into the second opening, and an insertion direction of the memory card into the card slot are made to be a first single direction.

### BRIEF DESCRIPTION OF THE DRAWINGS

FIG. 1 is a perspective view of an external configuration of a multi-function device 1 according to one embodiment.

FIG. 2 is an external perspective view of the multi-function device 1 showing where an opening 4 and an opening 73 are opened.

FIG. 3 is a longitudinal sectional view showing an internal configuration of the multi-function device 1 according to one embodiment.

FIG. 4 is a partially enlarged view of a connector panel 95.

FIG. 5 is a side sectional view of a sheet feed tray 20.

FIG. 6 is a partially enlarged view showing the principal configuration of a printer unit 2.

FIG. 7 is a plan view showing the principal configuration of the printer unit 2.

FIG. 8 is a perspective view of the multi-function device 1.

FIG. 9 is a perspective view of the multi-function device 1.

FIG. 10 is a perspective view of a refill unit 70.

FIG. 11 is a sectional view taken along the line IX-IX in FIG. 10.

FIG. 12 is a perspective view of ink cartridges 52.

FIG. 13 is a sectional view taken along the line XI-XI in FIG. 12.

### DETAILED DESCRIPTION OF EMBODIMENTS

Referring now to the drawings, the present invention will be described in detail on the basis of the preferred embodiments.

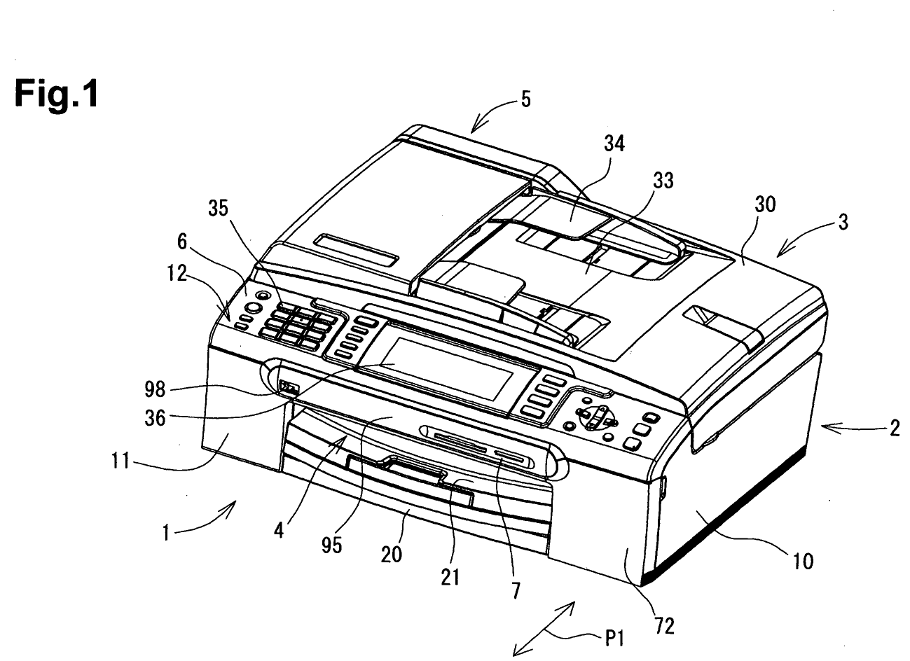

The multi-function device 1, as shown in FIGS. 1 to 3, is a multi-function device (“MFD”) in which an inkjet printing type printer unit 2, arranged in a lower portion of the device, and a scanner unit 3, arranged in an upper portion of the device, are integrally equipped. This multi-function device has multiple functions (e.g., a printer function, a scanner function, a copying function, a facsimile function, etc.). The printer unit 2 of the multi-function device 1 is an image printing device. Functions other than the printer function are optional. Accordingly, while the current embodiment is described as an MFD, the invention may also be embodied as a single-function printer without a scanner function or a copying function.

Regarding the printer function, the multi-function device 1 is connected to a computer (not shown), and the printer unit 2 prints an image or a document on a print medium (e.g., sheets of paper, etc.) on the basis of image data or document data transmitted from the computer. In addition, the printer unit 2 may print an image on a sheet on the basis of image data input from external apparatuses, such as digital cameras or USB (Universal Serial Bus) memory devices, connected to the multi-function device 1. Moreover, the printer unit 2 prints an image or document on a sheet even on the basis of the image data stored in various storage media, such as memory cards, which are mounted on the multi-function device 1.

Regarding the scanner function, the image data of a document is read by the scanner unit 3 and transmitted to a computer connected to the multi-function device 1 by radio or wire. Further, the scanned image data can be transmitted to, and stored in, various storage media (information storage devices), such as memory cards. Regarding the copying function, the image data read by the scanner unit 3 is printed on a sheet by the printer unit 2. Regarding the facsimile function, the image data read by the scanner unit 3 is facsimile-transmitted. Further, received facsimile data is printed on a sheet by the printer unit 2.

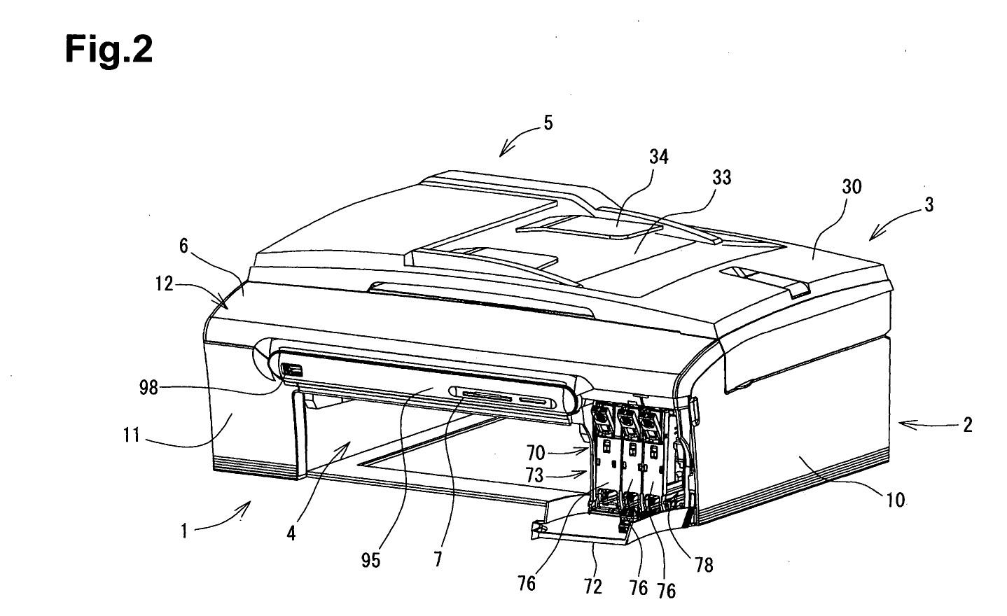

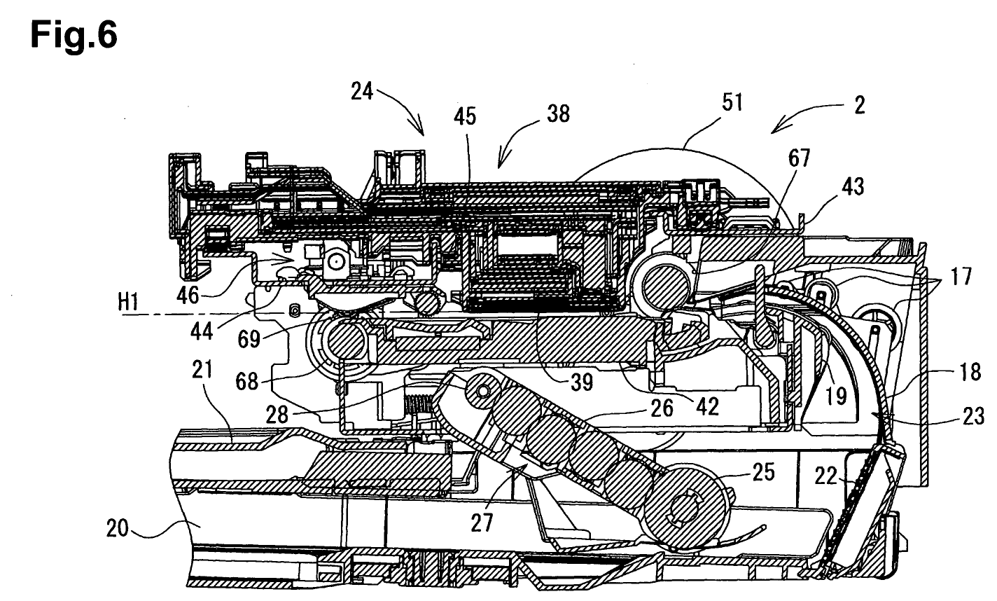

As shown in FIGS. 1 and 2, the external appearance of the multi-function device 1 is formed in the shape of a substantially wide thin parallelepiped whose width and depth are greater than height. The printer unit 2 has a housing 10 that constitutes a frame of the printer unit 2. The housing 10 has a front panel 11. An opening 4 (first opening) is formed in the front panel 11. The sheet feed tray 20 (first tray) and sheet discharge tray 21 (second tray) are provided in lower and upper stages respectively inside the opening 4. A connector panel 95 is arranged above the opening 4. Further, a refill unit 70, that reserves the ink to be supplied to a printhead 39 (refer to FIG. 6), is mounted to a right end of the front panel 11 in its width direction.

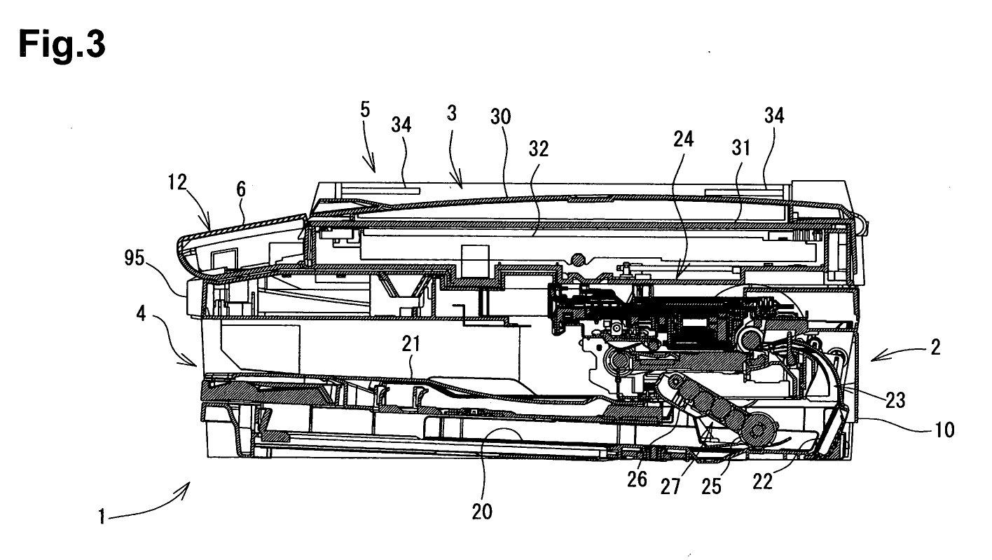

The scanner unit 3 is configured as a so-called flat bed scanner. As shown in FIGS. 1 through 3, a platen glass 31 and an image sensor 32 are provided below a document cover 30. The document cover 30 is provided in an openable/closable manner as a ceiling plate of the multi-function device 1. A document whose image is to be read is placed on the platen glass 31. Below the platen glass 31, the image sensor 32 is provided so that it can reciprocate in the width direction (direction vertical to the sheet plane of FIG. 3) of the multi-function device 1. The width direction of the multi-function device 1 is the main scanning direction of the image sensor 32.

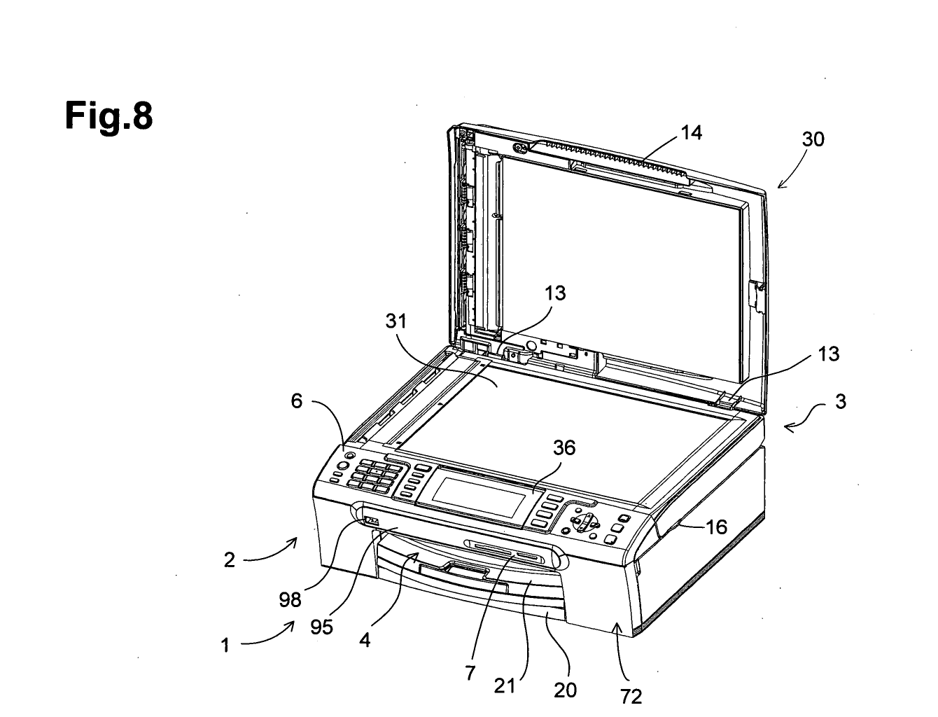

The document cover 30 is equipped with an ADF (Auto Document Feeder) 5 that continuously conveys documents to a sheet discharge tray 34 via a document conveying path (not shown) from a document tray 33. In the course of conveyance by the ADF 5, a document is conveyed onto the platen glass 31 (refer to FIG. 3), which acts as a document placement surface, and an image of the document is read by the image sensor 32 that is on standby below the platen glass 31. The document cover 30 is rotatable, through hinges 13, about its rear end as a rotation axis. The front end of the document cover 30 is provided with a finger rest 14 (refer to FIG. 8). As a result, a user can readily open the document cover by holding the finger rest from the front of the multi-function device 1, and directly see the document placed on the platen glass 31.

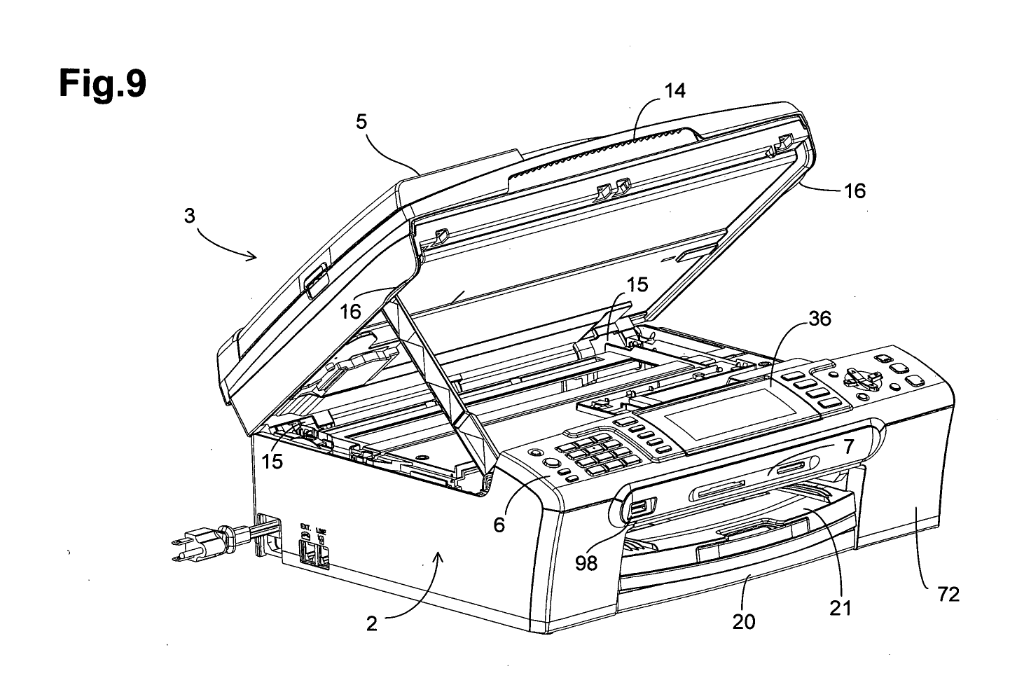

The scanner unit 3 is rotatable, through hinges 15, about its rear end as a rotation axis. In this way, the scanner unit 3 may be placed in a closed position (see FIG. 8) or an open position (see FIG. 9) with respect to the printer unit 2. The scanner unit 3 is provided with a finger rests 16 (refer to FIG. 9). As a result, a user can readily rotate the image reading device by holding the finger rests 16 to expose the inside of the printer unit 2. This enables a user to easily clear a paper jam from the front of the multi-function device 1.

An operation panel 6 that starts the printer unit 2 or scanner unit 3 is provided at the top of the multi-function device 1. The operation panel 6 is configured such that the various operation buttons 35 and the liquid crystal display (“LCD”) 36 are arranged appropriately. The multi-function device 1 may be started on the basis of an operation instruction from the operation panel 6. When the multi-function device 1 is connected to an external computer, the multi-function device 1 may also be started on the basis of an instruction transmitted from the computer via a printer driver or scanner driver.

As shown in FIG. 3, a panel surface 12 of the operation panel 6 is inclined forwardly downward by a predetermined angle from the horizontal plane. The panel surface 12 is inclined as described in order to facilitate operation of the multi-function device from the top when the multi-function device 1 is installed in a position lower than a user's eye line, as well as to facilitate operation of the multi-function device from the front when the multi-function device 1 is installed in a position higher than a user's eye line. The above predetermined angle is a factor that depends on the installation position of the multi-function device 1, and is preferably set to a range of 15° to 45°.

In the current embodiment operation panel 6 is located on the top of the printer unit 2 at a position in front of the scanner unit 3. Because the operation panel 6 is located on the top of the printer unit 2, the operation panel remains easily visible by a user even when the scanner unit 3 is in the open position (see FIG. 9). Since the liquid crystal display 36 is located on the operation panel 6, a user can place the scanner unit 3 in the open position so as to perform any necessary maintenance, while still clearly seeing any error message that may be provided on the liquid crystal display 36.

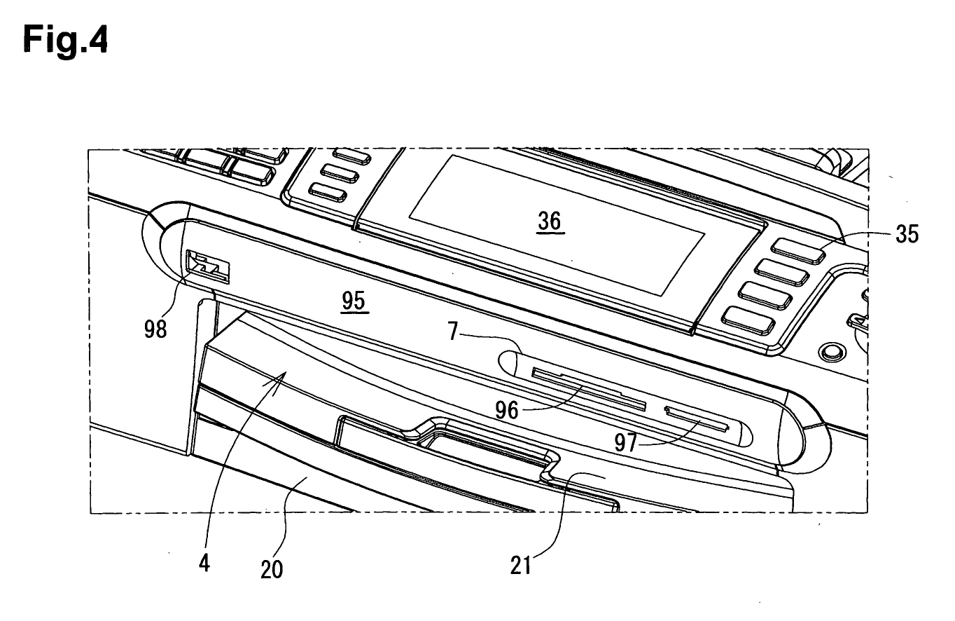

As shown in FIGS. 1 and 2, the front of the multi-function device 1 (i.e., the side facing the user when the user is operating the device) is provided with the connector panel 95 on which various connectors are arranged. The connector panel 95 is disposed above the opening 4 formed in the front panel 11. The connector panel 95, as shown in detail in FIG. 4, is formed in the shape of a strip that is slender and long in the width direction of the multi-function device, and is fitted into an opening (not shown) formed above the opening 4 via a known fitting mechanism.

A slot unit 7 is disposed at a right end of the connector panel 95. Various information storage devices, such as memory cards, may be loaded into the slot unit 7, thereby electrically connecting a control unit of the multi-function device 1 to the information storage devices. Here, the information storage devices are memory cards. These memory cards are card-type storage devices that have a flash memory as their storage medium. Examples of memory cards include memory sticks®, smart media®, compact flashes®, SD memory cards®, and XD picture cards®. As shown in FIG. 4, a first card slot 96 and a second card slot 97 (connectors) are arranged in the slot unit 7 so as to allow different types of memory cards to be loaded thereinto. The card slots 96 and 97 are provided so that memory cards can be inserted and pulled out in the direction perpendicular to the front panel 11, that is, in the depth direction of the multi-function device (refer to the arrow P1 in FIG. 1). Further, the card slots 96 and 97 are arranged horizontally so that memory cards can be inserted and pulled out while the front and back faces of the memory cards are kept horizontal.

Further, as shown in FIG. 4, the first card slot 96 and the second card slot 97 are arranged side by side. Accordingly, the slot unit 7 can be designed to have a low height. In addition, the number, or type, of the card slots provided in the slot unit 7 can be modified depending on the memory cards to be loaded.

When a memory card is loaded into the slot unit 7, the control unit of the multi-function device 1 accesses the memory card, thereby reading the image data stored in the memory card. When the image data is read, information about the image data is displayed on the liquid crystal display 36 of the operation panel 6. A user selects an image based on the information displayed on the liquid crystal display 36, and the selected image data is transmitted to the printer unit 3. The image data is then printed on a sheet. In addition, input for selection of an image by a user may be performed from the operation panel 6.

A USB connector 98 is arranged at a left end of the connector panel 95. The USB connector 98 is a connector that connects a USB memory (an example of an information storage device) having a USB terminal, a USB cable, or the like with the multi-function device 1. The USB connector 98 is provided so that a user can insert and pull out the USB memory in a direction perpendicular to the front panel 11 of the multi-function device 1, that is, in the depth direction (refer to the arrow P1 in FIG. 1) of the multi-function device as shown in FIG. 1. Of course, the number of USB connectors 98 in the connector panel 95 can be changed appropriately, and is not limited to one. In addition, although not shown in FIG. 4, an IEEE 1394 terminal complying with the IEEE standard may also be provided in the connector panel 95.

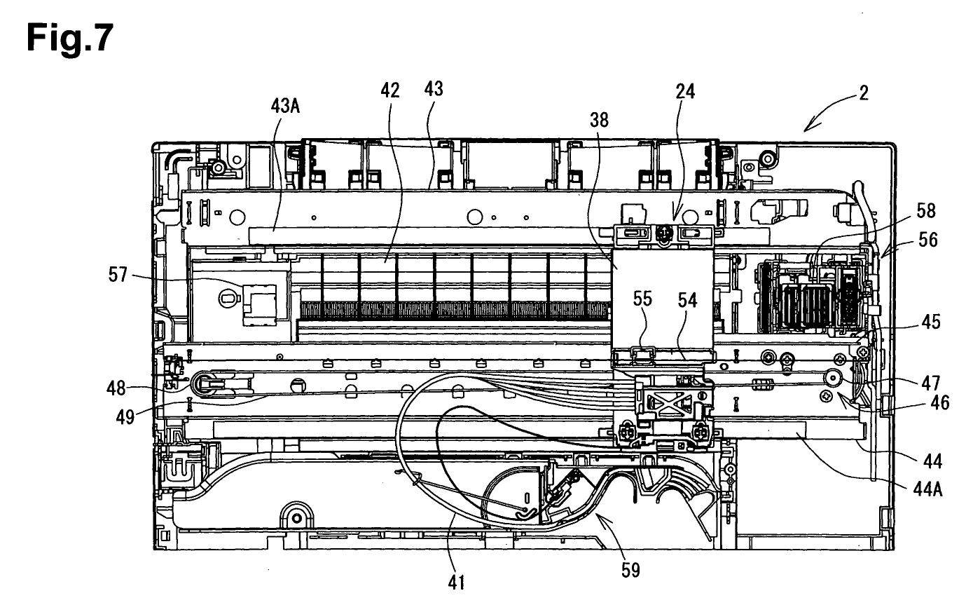

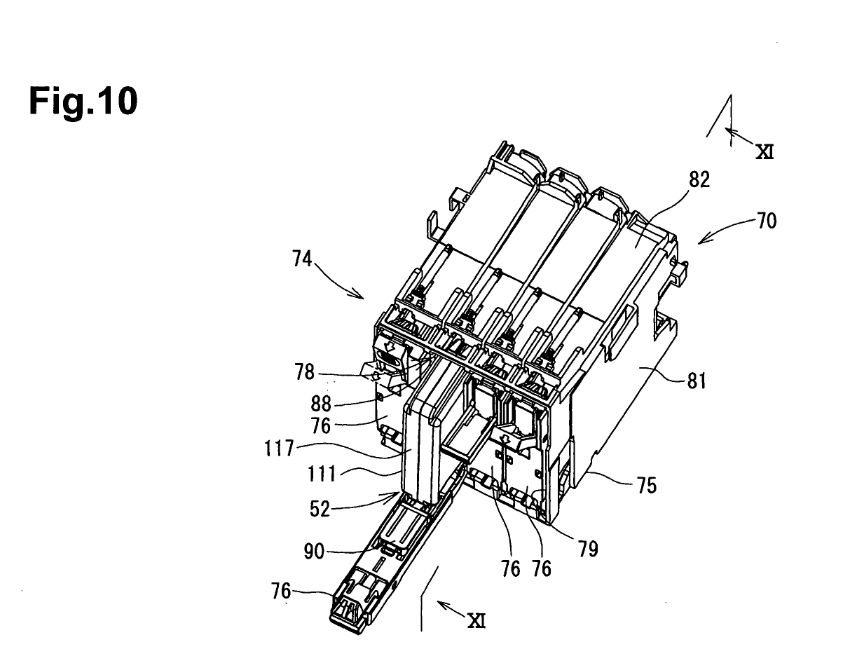

As shown in FIG. 2, the printer unit 2 includes the refill unit 70. The refill unit 70 is built on the front side of the housing 10 of the printer unit 2, that is, on the side of the front panel 11. In the present embodiment, the refill unit 70 can accommodate and hold four ink cartridges 52 (refer to FIG. 10). Black, yellow, magenta, and cyan inks are contained in each of the ink cartridges 52 respectively. These ink cartridges 52 are configured such that the inks reserved in the cartridges are supplied to the printhead 39 via ink tubes 41 (refer to FIG. 7).

As shown in FIG. 2, the housing 10 of the printer unit 2 has an openable/closable door 72 at the front panel 11. The door 72 opens and closes an opening 73 (second opening) provided at one end (right end in the present embodiment) of the front panel 11 in the width direction. Specifically, the door 72 is adapted to be rotatable between an opened posture, in which the door 72 is opened by being tilted forward to expose the refill unit 70 from the opening 73, and a closed postured, in which the door 72 is tilted upward to close the refill unit 70. The opening and closing operation of the door 72 is achieved by the door 72 rotating about its lower end as the axis of rotation.

As shown in FIG. 2, the opening 4 is formed in a central part of the front panel 11 in its width direction, and is formed slightly below the center of the front panel 11. A lower end of the opening 4 extends to the bottom face of the multi-function device 1. Print media, in this case sheets, are housed in the sheet feed tray 20. The sheet feed tray 20 can house sheets of various sizes (e.g., B5 size, postcard size, A4 size, etc.). The sheet feed tray 20 has a slide tray (not shown). When pulled out, the slide tray enlarges the tray surface of the sheet feed tray 20, allowing the sheet feed tray 20 to hold legal-sized sheets.

As shown in FIG. 3, the sheet feed tray 20 is disposed at the bottom of the multi-function device 1. The sheet feed tray 20 is configured such that it can be inserted into, or pulled out of, the opening 4 in the direction of the arrow P1 (in the right-and-left direction in FIG. 3) shown in FIG. 1. That is, the sheet feed tray 20 is configured so that it can be inserted and pulled out in the same direction as the inserting and pulling direction of the above-mentioned memory cards or USB memories.

The sheet feed tray 20 and the sheet discharge tray 21 may alternately be formed integrally with the housing 10. In this case, it is necessary to secure a work space above each tray for replacing the sheets housed in the sheet feed tray 20 with other sheets having different sizes, replenishing the sheet feed tray 20 with sheets, and removing sheets from the sheet discharge tray 21. However, such an arrangement is not preferable because the multi-function device 1 then increases in height. As a result, a problem occurs that the multi-function device becomes unnecessarily large.

To solve this problem, the present embodiment enables the sheet feed tray 20 and the sheet discharge tray 21 to be inserted into and pulled out of the opening 4 of the multi-function device 1. This configuration allows replenishment, replacement, or removal of sheets after the sheet feed tray 20 and the sheet discharge tray 21 have been pulled out of the multi-function device 1. Therefore, a work space above each tray can be eliminated, and the height, and overall size, of the multi-function device can be decreased. In the current embodiment, the sheet feed tray 20 is a box that is open in an upward direction, and the discharge tray 21 is an upper cover that covers the sheet feed tray 20.

When the sheet feed tray 20 is inserted into the opening 4 and mounted to the inside of the multi-function device 1, a sheet is pulled out in the right direction (conveying direction) in FIG. 3 by a sheet feed roller 25 as will be described below, and fed to an image printer 24. The sheet is fed along a sheet conveying path 23 having a sideways, U-shaped cross section. Further, the user can replenish the sheets in the sheet feed tray 20 by pulling the sheet feed tray 20 out from the inside of the multi-function device 1. In addition, the bottom of the sheet feed tray 20 becomes the bottom of the multi-function device 1 when the sheet feed tray 20 is inserted into the multi-function device.

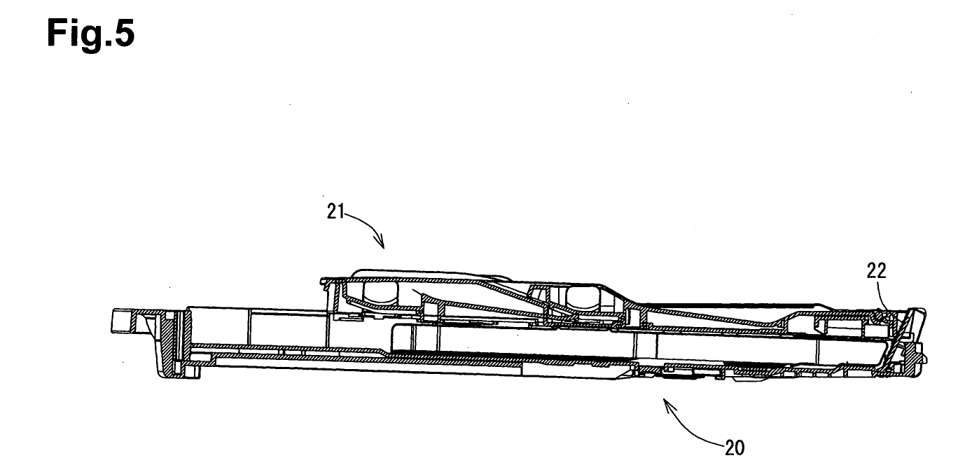

As shown in FIG. 5, the discharge tray 21 is arranged above the sheet feed tray 20. A sheet on which an image has been printed by the image printer 24 is discharged to the sheet discharge tray 21 with its print surface kept horizontal. In the present embodiment, the sheet feed tray 20 and the discharge tray 21 are configured integrally. Further, as shown in FIGS. 3 and 5, the sheet feed tray 20 and the discharge tray 21 are disposed inside the opening 4 with their sheet-placing surfaces kept horizontal. Accordingly, the sheets housed in the sheet feed tray 20, and the sheets discharged to the discharge tray 21 are held with their print surfaces being horizontal. Although the present embodiment has the sheet feed tray 20 and the discharge tray 21 are configured integrally, the trays may be separate from one another.

As shown in FIGS. 3 and 5, an inclined separation plate 22 is provided on a side of the sheet feed tray 20 such that it is inclined to tilt towards the back of the multi-function device. The inclined separation plate 22 separates a sheet fed from the sheet feed tray 20 and guides it upward. The sheet conveying path 23 is formed above the inclined separation plate 22. The sheet conveying path 23 is turned upward from the inclined separation plate 22, and then bent toward the front, extending from the back towards the front of the multi-function device 1, and leading to the discharge tray 21 through the image printer 24. A sheet housed in the sheet feed tray 20 is guided along the sheet conveying path 23, to the image printer 24. Then, after the image is printed on the sheet by the image printer 24, the sheet is discharged to the discharge tray 21.

The sheet feed roller 25 is provided above the sheet feed tray 20 as shown in FIG. 6. In addition, a mechanism, including the sheet feed roller 25, a convey roller 67, and a discharge roller 68, conveys a sheet toward the front of the multi-function device via the sheet conveying path 23. This is one example of a conveying means of the invention. The sheet feed roller 25 is brought into pressure contact with an uppermost sheet stacked on the sheet feed tray 20, so as to feed the uppermost sheet to the inclined separation plate 22. The sheet feed roller 25 is connected to a leading end of a sheet feed arm 26. The sheet feed roller 25 is rotated by a driving motor (not shown). The driving motor is connected to the sheet feed roller 25 via a driving transmission mechanism 27 in which a plurality of gears mesh with one another.

The sheet feed arm 26 is moved up and down with a base shaft 28 as the axis of rotation. In this way, the sheet feed arm 26 can be brought into contact with or separated from the sheet feed tray 20. As shown in FIG. 6, the sheet feed arm 26 is rotated downward by its own weight, whereby the sheet feed roller 25 is brought into contact with sheet feed tray 20. The sheet feed arm 26 is retracted upward when the sheet feed tray 20 and the discharge tray 21 are inserted into, or pulled out, of the opening 4. When the sheet feed roller 25 is in pressure contact with the surface of an uppermost sheet on the sheet feed tray 20, the uppermost sheet is fed to the inclined separation plate 22 by a frictional force between the roller surface of the sheet feed roller 25 and the uppermost sheet. The sheet abuts the inclined separation plate 22 at its leading end, and is guided upward, that is, to the sheet conveying path 23. The simultaneous delivery of a sheet right below the uppermost sheet along with the uppermost sheet itself is suppressed by the inclined separation plate 22.

Although there is a case where a sheet right below the uppermost sheet is delivered together by the action of friction or static electricity when the uppermost sheet is delivered by the sheet feed roller 25, the delivery of the sheet right below the uppermost sheet is suppressed by the inclined separation plate 22.

The sheet conveying path 23 is comprised of an inner guide surface and an outer guide surface that face each other with predetermined spacing. In the current embodiment, the sheet conveying path 23 is configured by fixing an outer guide member 18 and an inner guide member 19 to the inside of the frame. The outer guide member 18 is provided with conveying rollers 17. The conveying rollers 17 are exposed at their roller surfaces through the guide surface of the outer guide member 18, and are rotatably supported by the outer guide member 18. The axial direction of the conveying rollers 17 is the width direction of the sheet conveying path 23. The conveying rollers 17 smoothly convey the sheet that makes contact with the outer guide surface in a place where the sheet conveying path 23.

As shown in FIG. 6, the sheet conveying path 23 is provided with an image printer 24. The image printer 24 includes a carriage 38 that carries the printhead 39, and reciprocates in the main scanning direction (i.e., the direction perpendicular to the plane of FIG. 6). The printhead 39 is supplied with ink from the ink cartridges 52 (refer to FIG. 10) and selectively discharges the ink as fine ink droplets. An image is printed on the sheet conveyed on the platen 42 by selectively discharging the ink droplets from the printhead 39 while the carriage 38 reciprocates.

As shown in FIG. 7, guide rails 43 and 44 are located above the sheet conveying path 23 and extend in a direction orthogonal to the conveying direction of sheets (right-and-left direction in FIG. 7). The guide rails 43 and 44 are spaced apart from each other by a predetermined distance in the conveying direction of sheets (up-and-down direction of FIG. 7). The carriage 38 is placed standing astride the guide rails 43 and 44 so that it can reciprocate in a horizontal direction orthogonal to the conveying direction of sheets (left and right directions in FIG. 7).

A belt driving mechanism 46 is provided along the guide rail 44 on its top face. The belt driving mechanism 46 is configured such that an endless annular timing belt 49, having teeth provided at the inner side thereof, is stretched between a driving pulley 47 and a driven pulley 48. The driving pulley 47 and the driven pulley 48 are provided in the vicinity of both ends the sheet conveying path 23 in its width direction. By connecting the timing belt 49 with the carriage 38, the carriage 38 can be reciprocated on the basis of the operation of the belt driving mechanism 46.

The carriage 38 is connected to the timing belt 49. When the timing belt 49 moves, the carriage 38 reciprocates on the guide rails 43 and 44 with an edge 45 as a basis. The printhead 39 is carried on the carriage 38, so that the printhead 39 can reciprocate in the width direction of the sheet conveying path 23.

As shown in FIG. 7, a platen 42 is provided below the sheet conveying path 23 so as to face the printhead 39. The platen 42 is arranged within the reciprocal range of the carriage 38, in the center portion through which the sheets pass. The width of the platen 42 is sufficiently greater than the maximum width of a conveyable sheet, such that both ends of the sheet pass over the platen 42.

As shown in FIG. 6, the convey roller 67 is provided on the upstream side of the image printer 24. Although not shown in FIG. 6, a pinch roller is provided in the position where it faces the convey roller 67. The pinch roller is biased so that it may be brought into pressure contact with the convey roller 67. When the sheets enter the space between the convey roller 67 and the pinch roller, the pinch roller retreats by the thickness of the sheet, and, together with the convey roller 67, pinches the sheet. Thereby, the rotary power of the convey roller 67 is positively transmitted to the sheet, conveying the sheet onto the platen 42.

The discharge roller 68 is provided on the downstream side of the image printer 24. A spur roller 69 is provided in the position where it faces the discharge roller 68. The spur roller 69 is brought into pressure contact with the discharge roller 68. The discharge roller 68 and the spur roller 69 pinch and convey a sheet on which printing has been performed. The spur roller 69 biased so that it may be brought into pressure contact with the discharge roller 68, similarly to the pinch roller. However, the spur roller is brought into pressure contact with a sheet on which printing has been performed. Thus, the surface of the spur roller is made concave or convex in the shape of a spur so that an image printed on the sheet will not be deteriorated by the spur roller.

The driving force from a motor (not shown) is transmitted to the convey roller 67 and the discharge roller 68 so as to intermittently drive them with a predetermined linefeed width. The rotation of the convey roller 67 and the discharge roller 68 are synchronized with one another. A rotary encoder (not shown) is provided in the convey roller 67. The rotary encoder includes an encoder disc 51 that rotates with the convey roller 67. When the encoder 51 is detected by a photo-interrupter (not shown), the rotation of the convey roller 67 and the rotation of the discharge roller 68 are controlled.

Referring to FIGS. 2 and 10, the refill unit 70 holds four ink cartridges 52 corresponding to ink colors cyan (C), magenta (M), yellow (Y), and black (Bk), respectively. The refill unit 70 is arranged in a deep portion of the opening 73. In order to facilitate replacing the ink cartridges 52, the refill unit 70 is provided on the side of the front panel 11, and is arranged such that a front face 79 of a case 75 becomes almost flush with the front panel 11. The refill unit 70 is provided in the opening 73 in such a manner that the opening and closing of the opening 73 by the openable/closable door 72 is not hindered.

The refill unit 70, as shown in FIG. 10, includes a main unit 74. The ink cartridges 52 are adapted such that they are inserted into, or pulled out of, the main unit 74. Also, the ink cartridges 52 are actively held in the main unit 74 when they are inserted into the main unit 74.

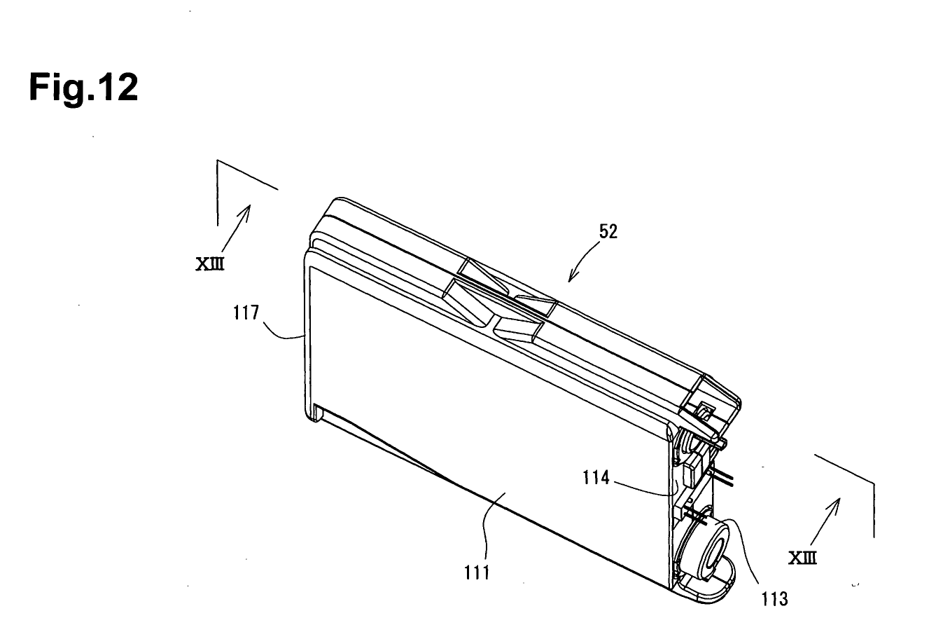

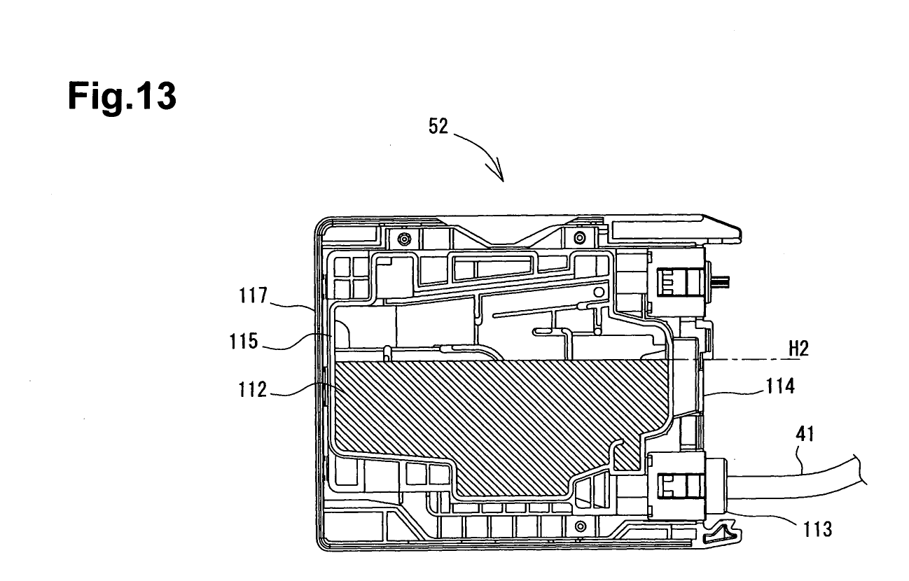

As shown in FIGS. 12 and 13, each of the ink cartridges 52 includes a main cartridge 111, and ink 112 stored in an ink tank 115 provided inside the main cartridge 111. The main cartridge 111 is provided with a connection 113 to which each of the ink tubes 41 is connected. The connection 113 extends to the ink tank 115, and serves to lead the ink 112 within the ink tank 115 to the ink tube 41.

As shown in FIG. 10, the refill unit 70 is provided with four housing chambers 78 so that the refill unit 70 can house the four ink cartridges 52. Each of the four ink cartridges 52 contains one of the inks cyan, magenta, yellow, or black in its ink tank 115. As shown in FIGS. 12 and 13, the main cartridge 111 is formed in the shape of a narrow parallelepiped, that is, in a shape that is narrow in the width direction, is long in the height direction, and is long in the depth direction. In this embodiment, as seen in FIG. 2 or FIG. 10, only the ink cartridge 52 that reserves black ink (the left ink cartridge toward the front of the multi-function device) is made slightly larger in the width direction than the ink cartridges 52 of the other ink colors (the right three ink cartridges toward the front of the multi-function device). This is because, generally speaking, the black ink is consumed in larger quantities than any of the other ink colors. In addition, a slide groove or engaging groove is formed in the main cartridge 111 so as to facilitate smooth insertion and pull-out of each cartridge into or from each housing chamber 78. This slide groove or engaging groove also ensures that each ink cartridge 52 is securely held by each housing chamber 78.

The main unit 74 includes the case 75. The ink cartridges 52 are inserted into, or pulled out of, a door 76 provided in the case 75. The main unit 74 also includes a drawer member 77 provided in the door 76. In one embodiment, the case 75 is made of resin, and is formed substantially in the shape of a parallelepiped as a whole.

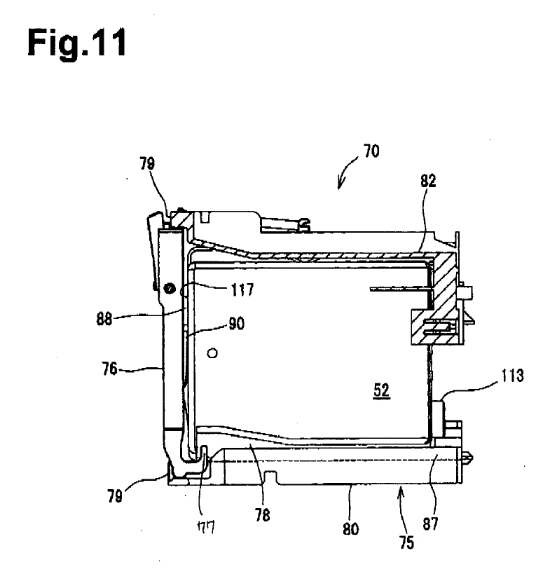

Referring to FIGS. 10 and 11, the case 75 includes a bottom plate 80, a pair of side plates 81 that are erected on both the right and left of the bottom plate 80, and a ceiling plate 82 disposed so as to be bridged between the side plates 81. Inside the case 75, the housing chambers 78 to house the ink cartridges 52, are respectively partitioned for every color (refer to FIG. 11). Specifically, partition walls 87 are erected from the bottom plate 80 of the case 75, and the housing chambers 78 are partitioned by the partition walls 87. The partition walls 87 extend in the depth direction of the case 75. Accordingly, the housing chambers 78 are partitioned sideways in the width direction of the case 75. The above-mentioned bottom plate 80, side plates 81, ceiling plate 82, and partition walls 87 are preferably formed integrally.

As shown in FIGS. 10 and 11, the front face 79 of the case 75 is provided with openings 88. The openings 88 are provided so as to correspond to the housing chambers 78, respectively. In other words, each of the housing chambers 78 is provided within the case 75 continuously with each of the openings 88. Each of the four ink cartridges 52 is adapted such that it can be inserted into, or pulled out of, each of the housing chambers 78 from the front face 79 side via each of the openings 88.

In addition, the shape of the inner wall of each of the housing chambers 78 corresponds to the shape of the outer peripheral surface of each of the ink cartridges 52. For this reason, each of the ink cartridges 52 is actively held in the case 75 without rattling.

Since the housing chambers 78 are partitioned in the manner described above, the ink cartridges 52 are vertically housed in the case 75 by inserting each of the ink cartridges 52 into a corresponding housing chamber 78 of the case 75 via a corresponding opening 88. Further, since each of the housing chambers 78 is partitioned sideways, the ink cartridges are held such that the ink liquid surface H2 (liquid surface when each ink cartridge is full of ink, refer to FIG. 13) of the ink 112 within each ink tank 115 becomes horizontal to the installation surface of the multi-function device 1, and the ink liquid surfaces H2 within the ink cartridges 52 all have the same height. Since the ink cartridges 52 are held in this manner, the negative pressures in inner holes of nozzles (not shown) of the printhead 39 corresponding to each color are kept substantially equal to each other. Accordingly, it is possible to realize a high image quality in that any defective ejection of ink caused by inequality of the negative pressures is prevented.

Since the refill unit 70 is arranged such that the front face 79 of the case 75 faces the front panel 11 of the printer unit 2, the insertion direction and pull-out direction of the ink cartridges 52 coincides with the depth direction of the multi-function device 1. Therefore, the insertion and pull-out directions of the ink cartridges 52 coincides with the insertion and pull-out directions of memory cards or USB memories relative to the slot unit 7 or the USB connector 98 respectively, and the insertion and pull-out direction of the sheet feed tray 20 relative to the opening 4.

The height of the ink cartridges 52 is obliged to be made low in order to make the multi-function device thin. Thus, it is necessary to elongate the ink cartridges 52 in the depth direction of the multi-function device 1 so as to enlarge the volume of the ink tank 115 in order to increase the volume of the ink 112. In addition, although the ink tank 115 may also be made wide as a technique of increasing the volume of ink, this is not preferable because the width of the multi-function device is disadvantageously increased. Accordingly, it is preferable that the ink cartridges 52 are elongated in the depth direction of the multi-function device as in the present embodiment so as to effectively utilize empty space in the depth direction of the multi-function device 1.

The partition walls 87 are disposed according to the number of ink cartridges 52 to be housed in the case 75. Accordingly, in the present embodiment, the case 75 has four housing chambers 78 corresponding to the four color inks, and four ink cartridges 52 are adapted to be inserted into or pulled out of the housing chambers 78, respectively. For this reason, three partition walls 87 are formed in the case 75 so as to partition off the four housing chambers 78. Here, the partition walls 87 do not need to be provided so as to completely partition off the housing chambers 78, but just have to be formed in the shape of a rib that partitions off adjacent housing chambers 78 from each other at least at the bottom plate 80.

The case 75 includes an ink supply tube (not shown) in a deeper portion of each of the housing chambers 78. The ink supply tube connects each of the ink cartridges 52 with each of the ink tubes 41 (refer to FIG. 7). The ink within each ink cartridge 52 is delivered to the printhead 39 via the respective ink supply tube and the respective ink tube 41.

To house the ink cartridge 52 in the housing chamber 78, first, the rear face 114 of the ink cartridge 52 is inserted through the opening 88 of the housing chamber 78. Thereafter, the above housing of the ink cartridge 52 is completed by closing the door 76. In this case, when the door 76 is closed, a protruding pressing and holding member 90 (refer to FIGS. 10 and 11) that is provided in the inner surface of the door 76 elastically presses a front face 117 of the ink cartridge 52. Thereby, the ink cartridge 52 is pushed into the depth direction of the housing chamber 78, and the ink supply tube engages the rear face 114 of the ink cartridge 52. In the current embodiment, the ink supply tube may include an ink supply needle that is stuck in the rear face 114 of the ink cartridge 52, and an ink supply valve that is opened when the ink supply needle engages the rear face 114 of the ink cartridge 52.

As described above, the opening 4 and the opening 73 are formed in the front panel 11 of the housing 10 of the printer unit 2. Further, the connector panel 95 is provided in the front panel 11. For this reason, a user of the multi-function device 1 can perform a plurality of tasks from the front of the multi-function device (e.g., replenishing or replacing sheets, connecting memory cards or USB memories, replacing the ink cartridges 52, etc.). Thereby, each of the above tasks becomes easier, and consequently the efficiency of each task improves.

Further, since the insertion and pull-out directions of the ink cartridges 52, memory cards, USB memories, and sheet feed tray 20 are unified, work space can be secured in a unified direction, and wasteful empty space is avoided. Consequently, it is possible to decrease the size of the installation space of the multi-function device 1. Moreover, since each task is performed in a unified direction, it is possible to guess other task directions from one task direction even when the task direction is not clear. It is also possible to perform the task without making an error in the task direction. Further, the form of the side faces and the top face of the multi-function device 1 can be simplified by integrating the opening 4, opening 73, and connector panel 95 in the front panel 11.

In an image printing device according to one embodiment of the current invention, a first opening, a second opening, and a card slot are formed at the front of the image printing device. This configuration allows a user to perform a plurality of operations from the front of the device (e.g., replenishing or replacing print media in the first tray, connecting a memory card to the card slot, replacing an ink cartridge, etc.). As a result, the plurality of operations are simplified, and the usability of the image printing device is improved.

The above-described operations are major operations repeatedly done by the user. By unifying the directions from which the user performs the above-described operations, a work space need only be provided in one direction with respect to the image printing device. Thus, an extra work space does not need to be provided in other directions. Accordingly, the footprint of the device can be reduced.

In this embodiment, the insertion direction of the first tray into the first opening, the insertion direction of an ink cartridge into the second opening, and the insertion direction of a memory card into the card slot are all unified into one and the same direction. Therefore, the user can perform the above-described operations without being confused about the operating direction.

Further, because the first opening, the second opening the and the card slot are integrated into the front of the image printing device, the top and sides of the image printing device can be simplified. In addition, various layouts of the first opening, the second opening, and the slot unit are possible on the front face. Thus, a wide rang of variations in design of the foreground side of the image printing device can be offered.

In an image printing device according to another embodiment of the current invention, the insertion direction of the first tray, the insertion direction of the ink cartridge, and the insertion direction of the memory cards are unified as a front-to-rear direction perpendicular to the front of the image printing device. Therefore, even a user who is not accustomed to the device can easily guess the operating direction (insertion direction).

In an image printing device according to yet another embodiment of the current invention, a second tray is arranged inside the first opening. Thus, a print medium, with an image printed thereon, that is held in the second tray can be easily removed from the front of the image printing device.

In another embodiment of the present invention, the directions of access to the front of the image printing device are unified into one direction and a direction opposite to the one direction, thereby improving the usability of the image printing device.

In yet another embodiment of the present invention, the image printing device is reduced in height.

In an image printing device according to another embodiment of the current invention, the portion where the card slot is disposed can be thin, thereby reducing the height of the image printing device.

In an image printing device according to yet another embodiment of the current invention, the slot units are arranged side by side at the front of the image printing devise, allowing connections of various kinds of memory cards without increasing the height of the image printing device.

In another embodiment of the present invention, the second opening is formed next to the first opening at one end of the front in a widthwise direction of the image printing device. Preferably, the second opening is formed to extend over the entire height of the image printing device and is enabled to house the ink cartridge. Usually the second opening has a parallelepiped or cubic shape and is greater in height than the first tray and the card slot combined, so as to meet the demand for storage of more ink.

In yet another embodiment of the present invention, the ink cartridges are held side by side. Thus, the ink printing device can be reduced in height and inks can be prevented from being mixed, as opposed to when the ink cartridges are arranged one above the other.

In an image printing device according to another embodiment of the current invention, the direction of access to the operation panel is a direction toward the front of the image printing device, thereby improving the usability of the image printing device.

In an image printing device according yet to another embodiment of the current invention, the opening and closing directions of the door for the second opening are directions toward and away from the front of the image printing device, thereby improving the usability of the image printing device.

In another embodiment of the present invention, the door for the second opening opens downward. Thus, the door for the second opening does not obstruct the user's view into the second opening, thereby facilitating the insertion and removal of the ink cartridge through the second opening. If the door opens rightward or leftward, the user is not allowed to directly see the second opening from the door opening direction.

In yet another embodiment of the present invention, an image reading device is disposed on the image printing device having simplified top and side faces. Thus, a low-profile multi-function device can be provided. In addition, the first opening, the second opening, and the card slot are integrally disposed at the front of the image printing device. Therefore, a space for disposing the image reading device is readily provided.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

What is claimed is:

1. An image printing device that ejects ink supplied from an ink cartridge to a sheet-like print medium to print an image on the sheet-like print medium, the image printing device comprising:
a first tray that holds a print medium on which an image is to be printed;
a first opening disposed at a front of the image printing device, in which the first tray is disposed;
a second opening disposed at the front of the image printing device, through which the ink cartridge is inserted and from which the ink cartridge is removed; and
a card slot disposed at the front of the image printing device, the card slot electrically connecting a memory card that stores image data to the image printing device;
wherein an insertion direction of the first tray into the first opening, an insertion direction of the ink cartridge into the second opening, and an insertion direction of the memory card into the card slot are made to be a first single direction.

2. The image printing device according to claim 1;
wherein the first single direction is a front-to-rear direction of the image printing device.

3. The image printing device according to claim 1, further comprising:
a conveying unit; and
a second tray that holds the print medium after an image has been printed on the print medium;
wherein the conveying unit conveys the print medium held in the first tray from the front of a image printing device to a rear of the image printing device;
wherein, after the conveying unit conveys the print medium from the front of the image printing device to the rear of the image printing device, the conveying unit conveys the print medium in a U-turn manner from the rear of the image printing device toward the front of the image printing device;
wherein, after the conveying unit conveys the print medium in a U-turn manner from the rear of the image printing device toward the front of the image printing device, the conveying unit conveys the print medium toward the front of the image printing device via a predetermined linefeed width; and
wherein the second tray is disposed inside the first opening such that the print medium on which the image has been printed is removable from the first opening.

4. The image printing device according to claim 3;
wherein a removal direction of the print medium on which the image has been printed from the second tray is a second single direction opposite to the first single direction.

5. The image printing device according to claim 4;
wherein the first tray horizontally holds the print medium on which an image is to be printed; and
wherein the second tray horizontally holds the print medium on which an image has been printed.

6. The image printing device according to claim 1;
wherein the memory card is inserted into, and removed from, the card slot while being held horizontally.

7. The image printing device according to claim 1;
wherein a plurality of card slots are arranged side by side at the front of the image printing device.

8. The image printing device according to claim 1;
wherein the first opening is formed in a lower portion of the front of the image printing device;
wherein the second opening is formed at one end of the front of the image printing device in a widthwise direction of the image printing device; and
wherein the card slot is disposed above the first opening.

9. The image printing device according to claim 1, further comprising:
a plurality of ink cartridges; and
a plurality of holding portions disposed inside the second opening to hold the plurality of ink cartridges respectively;
wherein each of the plurality of ink cartridges has a relatively long vertical dimension, a relatively short horizontal width dimension, and a relatively long dimension in an insertion direction of the plurality of ink cartridges into the second opening; and
wherein each of the plurality of ink cartridges are held in each of the plurality of holding portions respectively side by side in a vertical posture.

10. The image printing device according to claim 1, further comprising:
an operation panel disposed in a font upper portion of the image printing device;
the operation panel comprising:
input keys for inputting predetermined commands to the image printing device.

11. The image printing device according to claim 1;
wherein a door disposed at the front of the image printing device is attached to the second opening; and
wherein the door rotatable between a closed posture for closing the second opening and an open posture for opening the second opening by rotating frontward of the image printing device.

12. The image printing device according to claim 11;
wherein the door rotates frontward of the image printing device with a lower end of the door as its axis of rotation.

13. A multi-function device comprising:
an image printing device that ejects ink supplied from an ink cartridge to a sheet-like print medium to print an image on the print medium; and
an image reading device that is disposed above the image printing device so as to read an image of a predetermined document;
the image printing device comprising:
a first tray that holds a print medium on which an image is to be printed;
a first opening disposed at a front of the image printing device, in which the first tray is disposed;
a second opening disposed at the front of the image printing device, through which the ink cartridge is inserted and from which the ink cartridge is removed;
a card slot disposed at the front of the image printing device, the card slot electrically connecting a memory card that stores image data to the image printing device;
wherein an insertion direction of the first tray into the first opening, an insertion direction of the ink cartridge into the second opening, and an insertion direction of the memory card into the card slot are made to be a first single direction.

14. The image printing device according to claim 1;
wherein the ink is supplied to a printhead from the ink cartridge through a tube.

15. The image printing device according to claim 3;
wherein the first tray is removed from the first opening together with the second tray;
wherein the first tray is a box;
wherein a top of the first tray is open in an upward direction; and
wherein the second tray is an upper cover that covers the top of the first tray.

16. The image printing device according to claim 10;
the operation panel further comprising:
a liquid crystal display.

17. The multi-function device according to claim 13;
wherein the image reading device comprises:
a document placing surface; and
a document cover;
wherein the document cover rotates about a rear end of the document cover as its axis of rotation; and
wherein a finger rest is located at a front end of the document cover.

18. The multi-function device according to claim 13;
wherein the image reading device rotates between an open position with respect to the image printing device and a closed position with respect to an image printing device, with a rear end of the image reading device as its axis of rotation; and
wherein a finger rest is located at a front portion of the image reading device.

19. The multi-function device according to claim 18;
the image printing device further comprising:
an operation panel disposed in a front upper portion of the image printing device;
the operation panel comprising:
input keys for inputting predetermined commands to the image printing device; and
a liquid crystal display;
wherein the operation panel remains on the image reading device when the image reading device is in the open position with respect to the image printing device.

20. An image printing device comprising:
a first tray;
a first opening;
a second opening; and
a card slot;
wherein the first tray holds a print medium;
wherein the first opening is disposed at a front of the image printing device;
wherein the first tray is inserted through, and removed from, the first opening;
wherein the second opening is disposed at the front of the image printing device;
wherein an ink cartridge is inserted through, and removed from, the second opening;
wherein the card slot is disposed at the front of the image printing device;
wherein a memory card is inserted through, and removed from, the card slot; and
wherein an insertion direction of the first tray into the first opening, an insertion direction of the ink cartridge into the second opening, and an insertion direction of the memory card into the card slot are made to be a first single direction.
